(19) United States
(12) Patent Application Publication
(10) Pub. No.: US 2014/0010259 A1
(43) Pub. Date: Jan. 9, 2014

(54) TEMPERATURE TUNED FAILURE DETECTION DEVICE

(71) Applicants: JOSEPH STEVICK, North Tustin, CA (US); QUOC TRAN PHAM, Anaheim, CA (US); CHRISTOPHER D. PREST, San Francisco, CA (US); JOSEPH C. POOLE, San Francisco, CA (US); THEODORE A. WANIUK, Lake Forest, CA (US)

(72) Inventors: JOSEPH STEVICK, North Tustin, CA (US); QUOC TRAN PHAM, Anaheim, CA (US); CHRISTOPHER D. PREST, San Francisco, CA (US); JOSEPH C. POOLE, San Francisco, CA (US); THEODORE A. WANIUK, Lake Forest, CA (US)

(21) Appl. No.: 13/541,711

(22) Filed: Jul. 4, 2012

(51) Int. Cl. G01N 3/02

(52) U.S. Cl. 374/46

(57) ABSTRACT

The embodiments described herein relate to BMG parts and related failure detection devices. The BMG parts can be formed of a material including at least one or more amorphous alloys having binary physical properties in response to a temperature. The BMG parts can be configured in failure detection devices, which can be used for controlling and detecting failures, determining mechanical and temperature parameters, and/or providing protection and switching functions to an electronic system that contains the BMG parts and/or the failure detection devices.

### BACKGROUND

A large portion of the metallic alloys in use today are processed by solidification casting, at least initially. The metallic alloy is melted and cast into a metal or ceramic mold, where it solidifies. The mold is stripped away, and the cast metallic piece is ready for use or further processing. The as-cast structure of most materials produced during solidification and cooling depends upon the cooling rate. There is no general rule for the nature of the variation, but for the most part the structure changes only gradually with changes in cooling rate. On the other hand, for the bulk-solidifying amorphous alloys the change between the amorphous state produced by relatively rapid cooling and the crystalline state produced by relatively slower cooling is one of kind rather than degree—the two states have distinct properties.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. This amorphous state can be highly advantageous for certain applications. If the cooling rate is not sufficiently high, crystals may form inside the alloy during cooling, so that the benefits of the amorphous state are partially or completely lost. For example, one risk with the creation of bulk amorphous alloy parts is partial crystallization due to either slow cooling or impurities in the raw material.

Bulk-solidifying amorphous alloys have been made in a variety of metallic systems. They are generally prepared by quenching from above the melting temperature to the ambient temperature. Generally, high cooling rates, such as one on the order of 10⁵° C./sec, are needed to achieve an amorphous structure. The lowest rate by which a bulk solidifying alloy can be cooled to avoid crystallization, thereby achieving and maintaining the amorphous structure during cooling, is referred to as the “critical cooling rate” for the alloy. In order to achieve a cooling rate higher than the critical cooling rate, heat has to be extracted from the sample.

Until the early nineties, the processability of amorphous alloys was quite limited, and amorphous alloys were readily available only in powder form or in very thin foils or strips with a critical thickness of less than 100 micrometers. A class of amorphous alloys based mostly on Zr and Ti alloy systems was developed in the nineties, and since then more amorphous alloy systems based on different elements have been developed. These families of alloys have much lower critical cooling rates of less than 10³° C./sec, and thus they have much larger critical casting thicknesses than their previous counterparts. However, little has been shown regarding how to utilize these alloy systems into structural components, such as those in consumer electronic devices.

Thus, there is a need to provide BMG parts, BMG related devices, and their methods used for electronic devices/systems.

### SUMMARY

The embodiments described herein relate to BMG parts at least made of one or more bulk amorphous alloys having binary physical properties in response to a temperature.

The embodiments described herein also relate to failure detection devices formed including at least one BMG part. The failure detection devices can be used as, for example, a burst disc, a valve, a cotter pin-containing device, a partition separator, a trigger mechanism, etc.

The embodiments described herein further relate to methods of using the BMG parts and/or failure detection devices for: controlling and detecting failures, determining mechanical and temperature parameters, and/or providing protection and switching functions to an electronic system that contains the BMG parts and/or the failure detection devices. The electronic system can be an electric circuit system. The electronic system can include a fire sprinkler system.

In accordance with various embodiments, there is provided a failure detection device comprising at least a BMG part formed of a material including one or more amorphous alloys, wherein, in response to a temperature, the BMG part has a plasticity measured for failure prediction and/or has a mechanical strength at a temperature range provided for failure detection.

In accordance with various embodiments, there is provided a failure detection method by first providing a failure detection device including at least a BMG part. The BMG part has a first mechanical strength at a low temperature range and a second mechanical strength at a high temperature range. The failure detection device can then be heated; subjected to a mechanical strength while heating; and detected in response to the subjected mechanical strength at the high temperature range.

In accordance with various embodiments, there is provided a failure control method by first providing a failure detection device including at least a BMG part. The BMG part has a first mechanical strength at a low temperature range and a second mechanical strength at a high temperature range. The failure detection device can then be heated; subjected to a mechanical strength while heating; and failure predicted depending on if a plasticity of the BMG part is measured during the heating.

In accordance with various embodiments, there is provided a method of using a failure device by first providing a failure detection device including at least a BMG part. The BMG part has a first mechanical strength at a low temperature range and a second mechanical strength at a high temperature range. The failure detection device can then be heated and subjected to a mechanical strength while heating. The subjected mechanical strength can then be determined by measuring a plasticity of the BMG part in the failure detection device.

In accordance with various embodiments, there is provided a method of using a failure device by first providing a failure detection device including at least a BMG part. The BMG part has a first mechanical strength at a low temperature range and a second mechanical strength at a high temperature range. The failure detection device can then be heated with a mechanical strength applied thereto. The applied mechanical strength can be a value between the first and the second mechanical strengths of the BMG part. The heating process can be monitored by examining the BMG part of the failure detection device.

In accordance with various embodiments, there is provided a method of using a failure device. In this method, a BMG part can be selected according to a mechanical strength to be applied thereto such that the applied mechanical strength is between a first mechanical strength at a low temperature range of the BMG part and a second mechanical strength at a high temperature range of the BMG part. A failure detection device can be provided to include at least one BMG part and can then be heated to the high temperature range of the BMG part. The mechanical strength can be applied to the BMG part while heating such that a failure of the failure detection device can be obtained for further use.

### BRIEF DESCRIPTION OF THE DRAWINGS

FIG. 1 provides a temperature-viscosity diagram of an exemplary bulk solidifying amorphous alloy.

FIG. 2 provides a schematic of a time-temperature-transformation (TTT) diagram for an exemplary bulk solidifying amorphous alloy.

FIG. 3 illustrates a binary nature of an exemplary BMG part in accordance with various embodiments of the present teachings.

FIGS. 4-5 illustrate various embodiments of using a failure detection device including at least one BMG part in accordance with the present teachings.

FIG. 6 illustrates an exemplary BMG part in accordance with various embodiments of the present teachings.

FIGS. 7-10 illustrate exemplary failure detection devices each including an exemplary BMG part in accordance with various embodiments of the present teachings.

### DETAILED DESCRIPTION

All publications, patents, and patent applications cited in this Specification are hereby incorporated by reference in their entirety.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material. As a high degree of amorphicity (and, conversely, a low degree of crystallinity) is desirable in BMG parts, there is a need to develop methods for casting BMG parts having controlled amount of amorphicity.

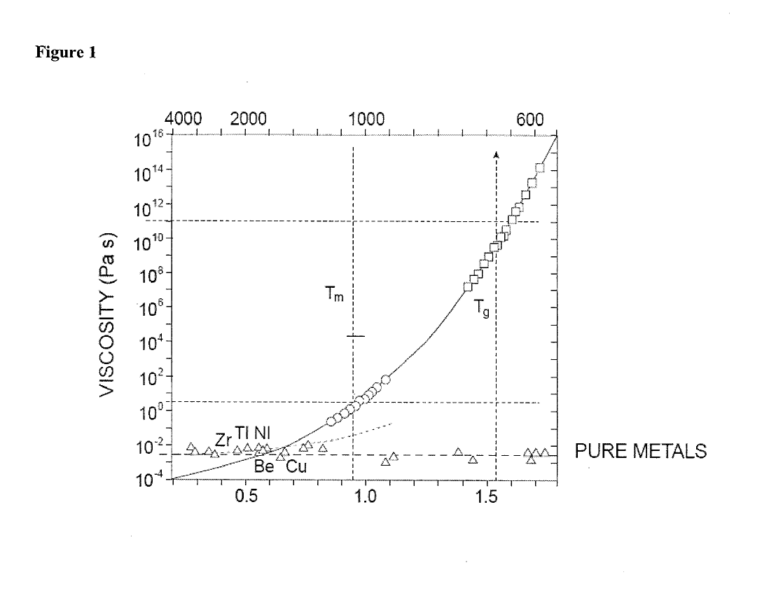

FIG. 1 shows a viscosity-temperature graph of an exemplary bulk solidifying amorphous alloy, from the VIT-001 series of Zr—Ti—Ni—Cu—Be family manufactured by Liquidmetal Technology. It should be noted that there is no clear liquid/solid transformation for a bulk solidifying amorphous metal during the formation of an amorphous solid. The molten alloy becomes more and more viscous with increasing undercooling until it approaches solid form around the glass transition temperature. Accordingly, the temperature of solidification front for bulk solidifying amorphous alloys can be around glass transition temperature, where the alloy will practically act as a solid for the purposes of pulling out the quenched amorphous sheet product.

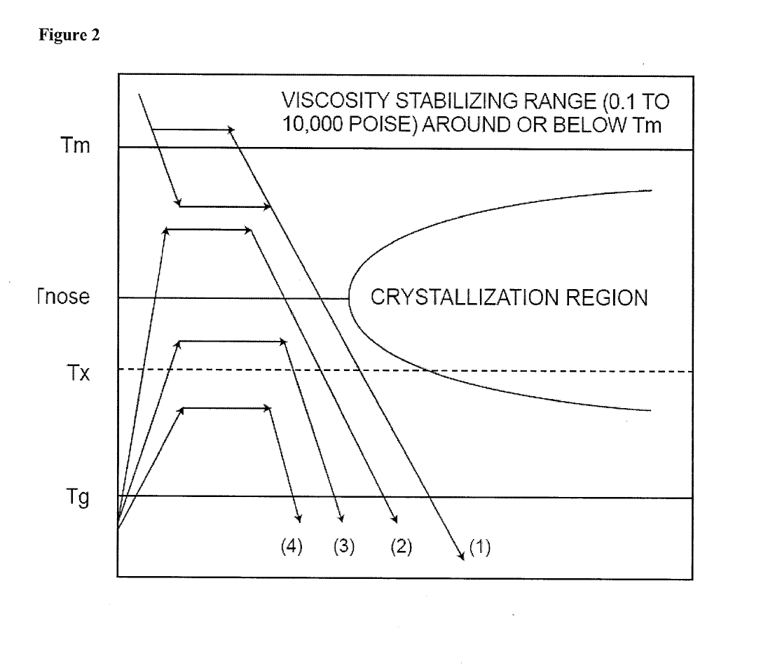

FIG. 2 (obtained from U.S. Pat. No. 7,575,040) shows the time-temperature-transformation (TTT) cooling curve of an exemplary bulk solidifying amorphous alloy, or TTT diagram. Bulk-solidifying amorphous metals do not experience a liquid/solid crystallization transformation upon cooling, as with conventional metals. Instead, the highly fluid, non crystalline form of the metal found at high temperatures (near a “melting temperature” Tm) becomes more viscous as the temperature is reduced (near to the glass transition temperature Tg), eventually taking on the outward physical properties of a conventional solid.

Even though there is no liquid/crystallization transformation for a bulk solidifying amorphous metal, a “melting temperature” Tm may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. A lower viscosity at the “melting temperature” would provide faster and complete filling of intricate portions of the shell/mold with a bulk solidifying amorphous metal for forming the BMG parts. Furthermore, the cooling rate of the molten metal to form a BMG part has to such that the time-temperature profile during cooling does not traverse through the nose-shaped region bounding the crystallized region in the TTT diagram of FIG. 2. In FIG. 2, Tnose is the critical crystallization temperature Tx where crystallization is most rapid and occurs in the shortest time scale.

The supercooled liquid region, the temperature region between Tg and Tx is a manifestation of the extraordinary stability against crystallization of bulk solidification alloys. In this temperature region the bulk solidifying alloy can exist as a high viscous liquid. The viscosity of the bulk solidifying alloy in the supercooled liquid region can vary between 10¹² Pa s at the glass transition temperature down to 10⁵ Pa s at the crystallization temperature, the high temperature limit of the supercooled liquid region. Liquids with such viscosities can undergo substantial plastic strain under an applied pressure. The embodiments herein make use of the large plastic formability in the supercooled liquid region as a forming and separating method.

One needs to clarify something about Tx. Technically, the nose-shaped curve shown in the TTT diagram describes Tx as a function of temperature and time. Thus, regardless of the trajectory that one takes while heating or cooling a metal alloy, when one hits the TTT curve, one has reached Tx. In FIG. 2, Tx is shown as a dashed line as Tx can vary from close to Tm to close to Tg.

The schematic TTT diagram of FIG. 2 shows processing methods of die casting from at or above Tm to below Tg without the time-temperature trajectory (shown as (1) as an example trajectory) hitting the TTT curve. During die casting, the forming takes place substantially simultaneously with fast cooling to avoid the trajectory hitting the TTT curve. The processing methods for superplastic forming (SPF) from at or below Tg to below Tm without the time-temperature trajectory (shown as (2), (3) and (4) as example trajectories) hitting the TTT curve. In SPF, the amorphous BMG is reheated into the supercooled liquid region where the available processing window could be much larger than die casting, resulting in better controllability of the process. The SPF process does not require fast cooling to avoid crystallization during cooling. Also, as shown by example trajectories (2), (3) and (4), the SPF can be carried out with the highest temperature during SPF being above Tnose or below Tnose, up to about Tm. If one heats up a piece of amorphous alloy but manages to avoid hitting the TTT curve, you have heated “between Tg and Tm”, but one would have not reached Tx.

Typical differential scanning calorimeter (DSC) heating curves of bulk-solidifying amorphous alloys taken at a heating rate of 20 C/min describe, for the most part, a particular trajectory across the TTT data where one would likely see a Tg at a certain temperature, a Tx when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 2, then one could avoid the TTT curve entirely, and the DSC data would show a glass transition but no Tx upon heating. Another way to think about it is trajectories (2), (3) and (4) can fall anywhere in temperature between the nose of the TTT curve (and even above it) and the Tg line, as long as it does not hit the crystallization curve. That just means that the horizontal plateau in trajectories might get much shorter as one increases the processing temperature.

### Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description of a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

### Metal, Transition Metal, and Non-Metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and that serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy (or “alloy composition”) can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof. Accordingly, for example, the alloy can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot, housing/casing of an electronic device or even a portion of a structural component that has dimensions in the millimeter, centimeter, or meter range.

### Solid Solution

The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and are generally capable of being separated. Generally, the two or more substances are not chemically combined with each other.

### Alloy

In some embodiments, the alloy composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term alloy herein can refer to both a complete solid solution alloy that can give single solid phase microstructure and a partial solution that can give two or more phases. An alloy composition described herein can refer to one comprising an alloy or one comprising an alloy-containing composite.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

### Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function: G(x,x′)= [symbol] s(x),s(x′) [symbol] .

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

### Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, and thin films Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The methods described herein can be applicable to any type of amorphous alloy. Similarly, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

For example, the amorphous alloy can have the formula (Zr, Ti)ₐ(Ni, Cu, Fe)_{b}(Be, Al, Si, B)_{c}, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)ₐ(Ni, Cu)_{b}(Be)_{c}, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)ₐ(Ni, Cu)_{b}(Be)_{c}, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)ₐ(Nb, Ti)_{b}(Ni, Cu)_{c}(Al)_{d}, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the afore described alloy system is a Zr—Ti—Ni—Cu—Be based amorphous alloy under the trade name Vitreloy™, such as Vitreloy-1 and Vitreloy-101, as fabricated by Liquidmetal Technologies, CA, USA. Some examples of amorphous alloys of the different systems are provided in Table 1.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe₇₂Al₅Ga₂P₁₁C₆B₄. Another example is Fe₇₂Al₇Zr₁₀Mo₅W₂B₁₅. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

The aforedescribed amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium and hafnium to form carbides and further improve wear and corrosion resistance. Further optional elements may include phosphorous, germanium and arsenic, totaling up to about 2%, and preferably less than 1%, to reduce melting point. Otherwise incidental impurities should be less than about 2% and preferably 0.5%.

TABLE 1
Exemplary amorphous alloy compositions

| Alloy | Atm % | Atm % | Atm % | Atm % | Atm % | Atm % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | Sn | |
| | 50.75% | 36.23% | 4.03% | 9.00% | 0.50% | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Au | Ag | Pd | Cu | Si | |
| | 49.00% | 5.50% | 2.30% | 26.90% | 16.30% | |
| 13 | Au | Ag | Pd | Cu | Si | |
| | 50.90% | 3.00% | 2.30% | 27.80% | 16.00% | |
| 14 | Pt | Cu | Ni | P | | |
| | 57.50% | 14.70% | 5.30% | 22.50% | | |
| 15 | Zr | Ti | Nb | Cu | Be | |
| | 36.60% | 31.40% | 7.00% | 5.90% | 19.10% | |
| 16 | Zr | Ti | Nb | Cu | Be | |
| | 38.30% | 32.90% | 7.30% | 6.20% | 15.30% | |
| 17 | Zr | Ti | Nb | Cu | Be | |
| | 39.60% | 33.90% | 7.60% | 6.40% | 12.50% | |
| 18 | Cu | Ti | Zr | Ni | | |
| | 47.00% | 34.00% | 11.00% | 8.00% | | |
| 19 | Zr | Co | Al | | | |
| | 55.00% | 25.00% | 20.00% | | | |

Other exemplary ferrous metal-based alloys include compositions such as those disclosed in U.S. Patent Application Publication Nos. 2007/0079907 and 2008/0118387. These compositions include the Fe(Mn, Co, Ni, Cu) (C, Si, B, P, Al) system, wherein the Fe content is from 60 to 75 atomic percentage, the total of (Mn, Co, Ni, Cu) is in the range of from 5 to 25 atomic percentage, and the total of (C, Si, B, P, Al) is in the range of from 8 to 20 atomic percentage, as well as the exemplary composition Fe₄₈Cr₁₅Mo₁₄Y₂C₁₅B₆. They also include the alloy systems described by Fe—Cr—Mo—(Y,Ln)-C—B, Co—Cr—Mo-Ln-C—B, Fe—Mn—Cr—Mo—(Y,Ln)-C—B, (Fe, Cr, Co)—(Mo,Mn)—(C,B)—Y, Fe—(Co,Ni)—(Zr,Nb,Ta)—(Mo,W)—B, Fe—(Al,Ga)—(P,C,B,Si,Ge), Fe—(Co, Cr,Mo,Ga,Sb)—P—B—C, (Fe, Co)—B—Si—Nb alloys, and Fe—(Cr—Mo)—(C,B)—Tm, where Ln denotes a lanthanide element and Tm denotes a transition metal element. Furthermore, the amorphous alloy can also be one of the exemplary compositions Fe₈₀P_{12.5}C₅B_{2.5}, Fe₈₀P₁₁C₅B_{2.5}Si_{1.5}, Fe_{74.5}Mo_{5.5}P_{12.5}C₅B_{2.5}, Fe_{74.5}Mo_{5.5}P₁₁C₅B_{2.5}Si_{1.5}, Fe₇₀Mo₅Ni₅P_{12.5}C₅B_{2.5}, Fe₇₀Mo₅Ni₅P₁₁C₅B_{2.5}Si_{1.5}, Fe₆₈Mo₅Ni₅Cr₂P_{12.5}C₅B_{2.5}, and Fe₆₈Mo₅Ni₅Cr₂P₁₁C₅B_{2.5}Si_{1.5}, described in U.S. Patent Application Publication No. 2010/0300148. Some additional examples of amorphous alloys of different systems are provided in Table 2.

TABLE 2
Exemplary amorphous alloy compositions

| Alloy | Atm % | Atm % | Atm % | Atm % | Atm % | Atm % | Atm % | Atm % |
|---|---|---|---|---|---|---|---|---|
| 1 | Fe | Mo | Ni | Cr | P | C | B | |
| | 68.00% | 5.00% | 5.00% | 2.00% | 12.50% | 5.00% | 2.50% | |
| 2 | Fe | Mo | Ni | Cr | P | C | B | Si |
| | 68.00% | 5.00% | 5.00% | 2.00% | 11.00% | 5.00% | 2.50% | 1.50% |
| 3 | Pd | Cu | Co | P | | | | |
| | 44.48% | 32.35% | 4.05% | 19.11% | | | | |
| 4 | Pd | Ag | Si | P | | | | |
| | 77.50% | 6.00% | 9.00% | 7.50% | | | | |
| 5 | Pd | Ag | Si | P | Ge | | | |
| | 79.00% | 3.50% | 9.50% | 6.00% | 2.00% | | | |
| 6 | Pt | Cu | Ag | P | B | Si | | |
| | 74.70% | 1.50% | 0.30% | 18.0% | 4.00% | 1.50% | | |

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

In one embodiment, the final parts exceeded the critical casting thickness of the bulk solidifying amorphous alloys.

In embodiments herein, the existence of a supercooled liquid region in which the bulk-solidifying amorphous alloy can exist as a high viscous liquid allows for superplastic forming. Large plastic deformations can be obtained. The ability to undergo large plastic deformation in the supercooled liquid region is used for the forming and/or cutting process. As oppose to solids, the liquid bulk solidifying alloy deforms locally which drastically lowers the required energy for cutting and forming. The ease of cutting and forming depends on the temperature of the alloy, the mold, and the cutting tool. As higher is the temperature, the lower is the viscosity, and consequently easier is the cutting and forming.

Embodiments herein can utilize a thermoplastic-forming process with amorphous alloys carried out between Tg and Tx, for example. Herein, Tx and Tg are determined from standard DSC measurements at typical heating rates (e.g. 20° C./min) as the onset of crystallization temperature and the onset of glass transition temperature.

The amorphous alloy components can have the critical casting thickness and the final part can have thickness that is thicker than the critical casting thickness. Moreover, the time and temperature of the heating and shaping operation is selected such that the elastic strain limit of the amorphous alloy could be substantially preserved to be not less than 1.0%, and preferably not being less than 1.5%. In the context of the embodiments herein, temperatures around glass transition means the forming temperatures can be below glass transition, at or around glass transition, and above glass transition temperature, but preferably at temperatures below the crystallization temperature T_{X}. The cooling step is carried out at rates similar to the heating rates at the heating step, and preferably at rates greater than the heating rates at the heating step. The cooling step is also achieved preferably while the forming and shaping loads are still maintained.

### Electronic Devices

The embodiments herein can be valuable in the fabrication of electronic devices using a BMG. An electronic device herein can refer to any electronic device known in the art. For example, it can be a telephone, such as a cell phone, and a land-line phone, or any communication device, such as a smart phone, including, for example an iPhone™, and an electronic email sending/receiving device. It can be a part of a display, such as a digital display, a TV monitor, an electronic-book reader, a portable web-browser (e.g., iPad™), and a computer monitor. It can also be an entertainment device, including a portable DVD player, conventional DVD player, Blue-Ray disk player, video game console, music player, such as a portable music player (e.g., iPod™), etc. It can also be a part of a device that provides control, such as controlling the streaming of images, videos, sounds (e.g., Apple TV™), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

### Embodiments

The embodiments described herein relate to BMG parts at least made of one or more bulk amorphous alloys having binary physical properties in response to a temperature.

The embodiments described herein also relate to failure detection devices formed including at least one BMG part. The failure detection devices can be used as, for example, a burst disc, a valve, a cotter pin-containing device, a partition separator, a trigger mechanism, etc.

The embodiments described herein further relate to methods of using the BMG parts and/or failure detection devices for: controlling and detecting failures, determining mechanical and temperature parameters, and/or providing protection and switching functions to an electronic system that contains the BMG parts and/or the failure detection devices. The electronic system can be an electric circuit system. The electronic system can include a fire sprinkler system.

As used herein, the term “failure” or “failure condition” is intended to be construed broadly so as to include, without limitation, any degree of failure of components (e.g., a BMG part) included in the failure detection device. Such failure can include, e.g., an actual failure of materials or material portions, a failure of assembly of components in the failure detection device, etc.

As used herein, the term “failure detection device” refers to a device that can be used to predict, control, detect, determine, and/or provide functionalities of a system such as an electronic system configured including the failure detection device. In specific embodiments, the term “failure detection device” can be referred to as a temperature tuned failure detection device when changing the temperature of the electronic system. In exemplary embodiments, the failure mechanism can be correlated with localized changes in temperature in responsive to an applied or exerted mechanical property.

In one embodiment, the failure detection device can be used to detect failure of the system. In another embodiment, the failure detection device can be used to predict or control failure of the system. In still another embodiment, the failure detection device can be used to predict, determine, or control, properties/conditions such as a mechanical property/a temperature condition of the system having the failure detection device. In yet another embodiment, the failure detection device can provide a passage, e.g., for venting and/or mixing of a pressurized gas and/or liquid, and/or can provide protection or switching functionalities in the system using the failure detection device. In embodiments, the system containing the failure detection device can be any electronic system. The failure detection device can be part of an electric circuit.

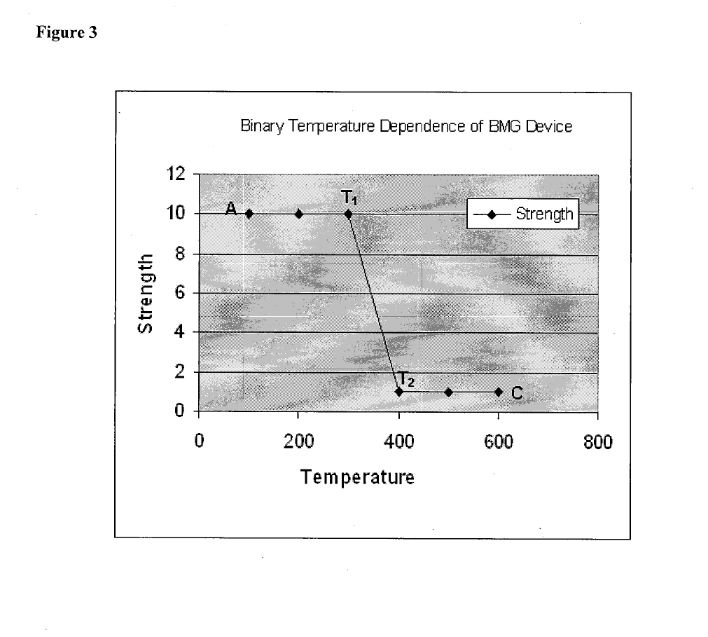

As used herein, the term “binary” refers to a nature of BMG properties such as physical properties including mechanical properties, where the BMG has a first physical property in a first temperature range and a second physical property at a second temperature range. In one example, the BMG materials can have a first (e.g., high) mechanical strength at a low temperature range and a second (e.g., low) mechanical strength at a high temperature range. The embodiments take advantage of the ‘binary’ nature of BMG mechanical properties, as described in detail in FIG. 3, where the binary switch is a specific location on a temperature scale. The ‘binary’ nature of BMG mechanical properties add temperature dependent functionality to electronic components without adding any additional temperature sensing systems or devices to implement a hardware change when certain temperature conditions are met.

FIG. 3 illustrates a binary nature of the mechanical properties of an exemplary given BMG part. Specifically, FIG. 3 provides a thermal-mechanical relationship for the given BMG part. In embodiments, the BMG part can be formed of a material including at least one or more amorphous alloys. Note that FIG. 3 is provided for illustrative purpose, other different BMG parts can be used as disclosed herein. Depending on the BMG part selected or used, e.g., depending on the selection of the one or more of the amorphous alloys and/or other non-amorphous materials used to form the BMG part, and/or depending on the shapes, dimensions, structures, and/or configurations of the BMG part, the thermal-mechanical relationship may be altered. For example, the glass transition temperature Tg, the crystallization temperature Tx, and/or other parameters can be tuned for different BMG parts and therefore for specific applications. In embodiments, the BMG part can have dimensions greater than the critical casting dimension of each alloy used to form the BMG part. The BMG part can be tuned or designed according to requirement of different physical properties such as mechanical properties.

As shown in FIG. 3, when the exemplary BMG part is heated to a first temperature range up to T1 (e.g., Tg of the amorphous alloy(s)), the BMG part is in an amorphous state A having a first physical property such as a high mechanical property. When the temperature is increased exceeding its Tg for example, the material of BMG part begins to soften as described in FIG. 2. The amorphous nature of the BMG materials is compromised, along with the physical/mechanical properties unique to the BMG material. When the temperature reaches a critical temperature T2, for example when the crystallization temperature Tx is reached or exceeded, the BMG part is in a crystalline state C, whereby holding a second physical property such as a low mechanical property.

Exemplary mechanical properties of BMG materials can include a mechanical strength, a fracture toughness, etc. in response to a temperature. The mechanical properties in the amorphous state A of the given BMG material before reach temperature Tg can be stronger or higher than that in the crystalline state C after reaching the crystallization temperature Tx. In certain embodiments, the temperature range corresponding to the amorphous state A having the first mechanical property is about Tg or less; while the temperature range corresponding to the crystalline state C having the second mechanical property is about Tx or higher.

Various embodiments include a heating-up mechanism for heating the BMG part and/or the failure detection device. The heating-up mechanism can be accomplished, e.g., by contact of the material/device with a solid, liquid or gaseous medium and can, for instance, be triggered mechanically, electrically (e.g., by current induction) and/or optically (e.g., by optical illustration).

Referring back to FIG. 3, if a mechanical mechanism, such as a mechanical strength of a force, or tensile stress, is exerted on the exemplary BMG part and is larger than the mechanical strength of the alloy(s) in the crystalline state C at the high temperature range of at least about Tx, a failure may occur to tear the BMG part. The mechanical mechanism can include any means for providing a mechanical strength such as a pressurized fluid, a tensioning device for producing a tension or a force which is in no way sufficient for tearing the BMG apart in an amorphous state, etc. The BMG part may be abruptly torn/broken, rather than gradually torn/broken. Reaching Tx therefore triggers a permanent change of the BMG part, which the part “remembers”. The amorphous alloys thus provide memory material application, where the BMG part remembers whether it has ever been above a certain temperature. Note that even after returning to below Tx, the BMG part material remains permanently altered in terms of strength related properties. Therefore, any forces that would not have exceeded the strength of the BMG device prior to being subjected to temperatures above the Tx point, will now cause the part to fail.

In addition to the loss of mechanical properties such as mechanical strength, fracture toughness, and other changes that accompany crystallization, amorphous alloys also soften significantly above the glass transition temperature Tg before crystallizing, which may have significance for, e.g., predicting failure of the system, depending on the configuration. For example, an amorphous alloy component or BMG part with a glass transition temperature of about 350° C. is used in a system of an electronic assembly where it is subjected to a mechanical strength, such as a constant load that is well below its room temperature (lower than Tx) yield stress. If the amorphous alloy component or BMG part experiences temperatures above 350° C., the amorphous alloy materials then provide a plasticity.

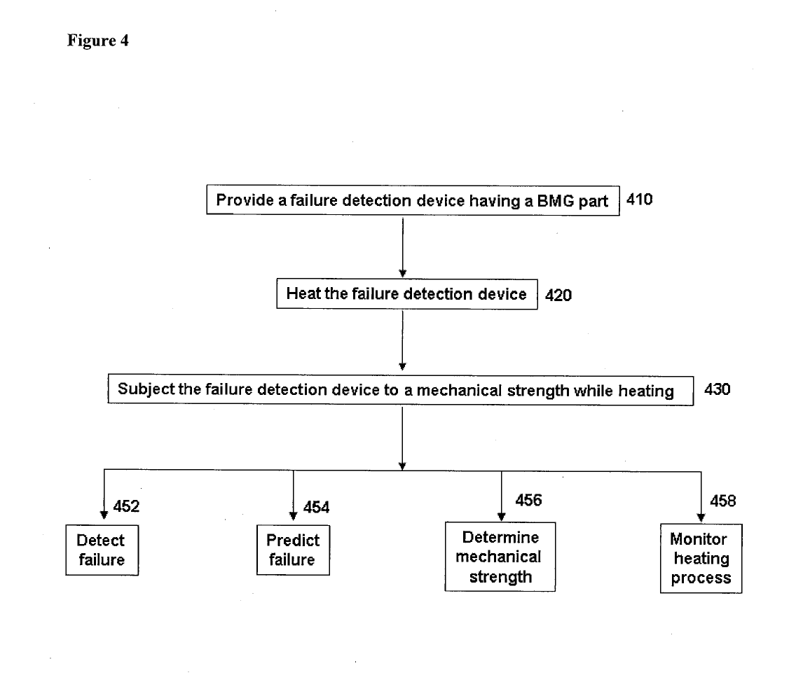

As used herein, the term “plasticity” describes the deformation of a material undergoing non-reversible changes of shape in response to applied forces. For example, if a plasticity is measured, that means the flow stress of the amorphous alloy(s) drops and the material begins to flow and/or change shape before it crystallizes. This plasticity can be used to predict a failure of the device containing the BMG part, to determine a range of the mechanical strength or a constant load applied, and/or to monitor the temperature change or the heating process as described below in FIG. 4. The plasticity can be measured, as known in the art, by measuring a ductility or a malleability of the BMG part in response to the applied or exerted mechanical strength. In other embodiments, for example, imaging systems such as infrared imaging systems can be used to monitor or measure plastic deformation of the BMG material, where line-of-sight contact can be made between the object (e.g., the BMG part) to be measured and a measuring camera lens.

FIGS. 4-5 depict use of the binary nature of any BMG part for exemplary failure detection devices.

At 410 of FIG. 4, exemplary failure detection device can include at least one BMG part. For example, the BMG part can have a first mechanical strength at a low temperature range and a second mechanical strength at a high temperature range. At 420 of FIG. 4, the failure detection device can then be heated and subjected to a mechanical mechanism/strength while heating (see 430).

At 452 of FIG. 4, the failure detection devices can be used for failure detection. A failure can be detected in response to the exerted or subjected mechanical strength on the BMG part at its high temperature range. For example, if the subjected mechanical strength is higher than one or more of the first and the second mechanical strengths of the BMG part, a failure can be detected by e.g., at least partially tearing or breaking the BMG part in the device, and/or providing a passage of a fluid through the failure detection device in the electronic system.

At 454 of FIG. 4, the failure detection devices can be used for failure prediction, if a plasticity of the BMG part is measured during the heating. The measurable plasticity means the subjected mechanical strength is higher than at least one of the first and the second mechanical strengths or between the first and the second mechanical strengths of the BMG part.

At 456 of FIG. 4, the failure detection devices can be used for determining the exerted mechanical strength by measuring the plasticity of the BMG part. For example, the mechanical strength can be determined to be higher than the lower mechanical strength at high temperature range of the BMG material, if the plasticity is measured or if the BMG part is observed to be capable of local re-shaping e.g., using a microscopic technique, and/or if a material or device failure is observed. On the other hand, if no plasticity or plastic deformation is observed or measured, the mechanical strength can be determined to be lower than the low mechanical strength determined by the BMG part at the high temperature range.

At 458 of FIG. 4, the failure detection devices can be used for monitoring the heating process or a temperature control of the electronic system using the disclosed failure detection device by examining the BMG part. For example, the BMG part can be examined by measuring the plasticity or observing a failure of the failure detection device. In one case, if the plasticity is measured, the heating temperature can be known to be between Tg and Tx of the amorphous alloys used for the BMG part. However, if a failure of the failure detection device is observed, the heating temperature can be known to be at least about Tx of the amorphous alloys used for the BMG part.

In this manner, as depicted at steps 456 and 458 of FIG. 4, the binary nature of the amorphous alloys/BMG part can provide a means to determine mechanical and thermal parameters for its use.

FIG. 5 illustrates an exemplary method for obtaining a failure of the failure detection device so as to allow the entire system to operate correctly.

At 510, a BMG part can be selected according to a mechanical strength to be applied thereto. The selection of BMG part can be determined by selection of the amorphous alloy(s) and/or other materials used (e.g., non-amorphous metallic materials), the structures/dimensions/shapes of the BMG part, the configuration of the BMG part in the failure detection device, etc. The BMG part can be selected to provide suitable binary nature, e.g., having desired high and low mechanical properties each provided at a desired temperature range. The BMG part can be selected such that the mechanical strength to be applied is between a first mechanical strength at a low temperature range of the BMG part and a second mechanical strength at a high temperature range of the BMG part.

At 520, a failure detection device can be formed or provided by incorporating at least one BMG part selected at 510. At 530, the failure detection device including the at least one selected BMG part can be heated to the high temperature range of the BMG part. At 540, the mechanical strength can then be applied to the BMG part while heating; and at 550, a failure of the failure detection device can then be obtained because the applied mechanical strength is higher than the second mechanical strength of the BMG part at the high temperature range.

In embodiments, the failure of the failure detection device can be used to allow the entire system to operate correctly, for example, to provide protection such as pressure protection of the system, to provide a switch function to the system, to provide passage for various applications such as mixing and/or venting of various materials as desired. In one embodiment, the failure detection device can be a part of an electric circuit to protect the electric circuits against current overloads which are increasing slowly or suddenly and induce heat. For instance, a part of an electric circuit can be interrupted by tearing the BMG part in response to Joule heat induced by an amount of current travel there-through. The switching function can be triggered by tearing or failure of the BMG part itself either in the form of interrupting an electric circuit including the BMG part, or by a change of position that occurs during the rupture.

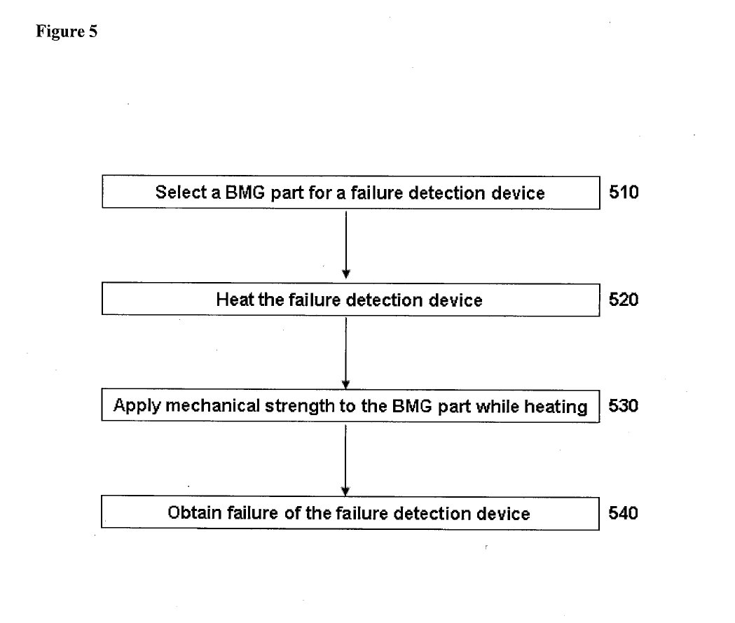

FIG. 6 depicts an exemplary BMG part 600 in accordance with various embodiments of the present teachings.

The exemplary BMG part 600 can be formed of materials including at least one or more amorphous alloys. The exemplary BMG part 600 can include one or more layers having at least one layer formed of one or more amorphous alloys. Note that although the part 600 in FIG. 6 depicts a two layer configuration (see layers 10 and 20 in FIG. 6), one of ordinary skill in the art will appreciate that the part 600 can include less than two or more than two layers with at least one layer formed of one or more amorphous alloys, which may or may not be formed throughout the entire layer. In one embodiment, the exemplary BMG part 600 can be a multi-metallic strip including at least one strip formed of the amorphous alloys throughout this at least one strip. Other possible configurations without limitations can be used for the BMG part 600.

In addition to using amorphous alloys, non-amorphous metals/metal alloys can be used to form the BMG part 600. For example, one or more metals selected from the group consisting of aluminum, bismuth, cobalt, copper, gallium, gold, indium, iron, lead, magnesium, mercury, nickel, potassium, plutonium, rare earth alloys, rhodium, silver, titanium, tin, uranium, zinc, zirconium, and mixtures thereof can be used.

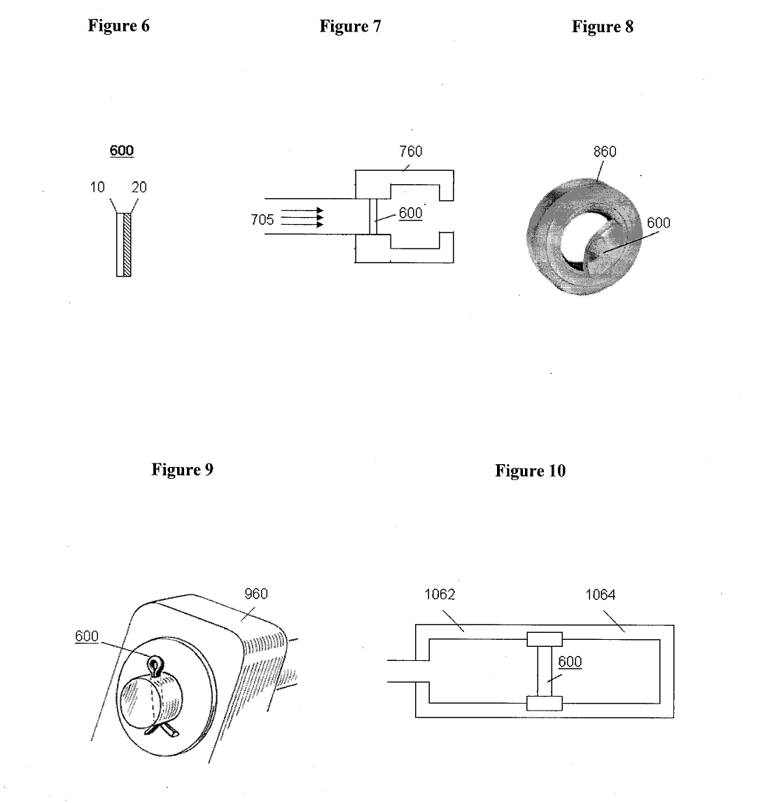

In embodiments, the BMG part 600, depending on its configurations and applications, can have various cross-sectional shapes including, e.g., rectangular strips as seen in FIGS. 6, 7, and 10, a sheet as seen in FIG. 8, a curved structure as seen in FIG. 9, etc. FIGS. 7-10 illustrate various exemplary failure detection device in accordance with various embodiments of the present teachings.

Each device shown in FIGS. 7-10 can have a holder 760, 860, 960, 1062, or 1064 for at least holding the BMG part 600. In embodiments, the holder can be a container, e.g., for containing pressurized fluid (gas and/or liquid), which in turn provide mechanical properties applied to the BMG part in the device. In embodiments, the BMG part holder can also be formed of one or more amorphous materials and/or other materials such as non-amorphous metallic materials and/or non-metallic materials as disclosed herein.

For exemplary illustration, the device depicted in FIG. 7 can be used as a valve, e.g., for hold back pressurized fluids, gases and/or liquids. The valve can be a pressure relief valve. Alternatively, the valve can be used to support a trigger mechanism, e.g., provide a reactant at certain temperature for triggering a chemical reaction or a physical mixing.

The device depicted in FIG. 8 can be used as a burst disc or burst diaphragm capable of withstanding a substantially higher back pressure (e.g., pressurized gas) than its burst activation pressure of the BMG part. Such device can be a non-reclosing pressure relief device that, in most uses, protects a pressure vessel, equipment or system from over-pressurization or potentially damaging vacuum conditions. During operation, the BMG part 600 in FIG. 8 can be a sacrificial part because it fails at a predetermined differential pressure, either positive or vacuum and has a one-time-use. Various amorphous materials and non-amorphous materials can be selected to suit particular applications.

In embodiments, the device shown in FIG. 9 can be a wheel, gear, lid, or other mechanism having the BMG part 600 used as an exemplary cotter pin to mechanically support or restrict the wheel, gear, lid, or other mechanism in a static or dynamic situation.

In embodiments, the device shown in FIG. 10 can be a failure detection device having a BMG part 600 configured as a partition separator between a first partition 1062 and a second partition 1064. The first partition 1062 can contain a first material (not shown) and the second partition 1064 can contain the second material. In embodiments, the first and the second materials can be reactants that requires physical mixing and/or chemical reaction at certain high temperatures under a desired pressure. Specifically, in response to the pressure at the certain high temperature, the BMG part 600 can be at least partially broken for providing passage of at least one of the first and the second materials such that they can be mixed for further process including a chemical reaction. In embodiments, the first material and/or the second material can be a liquid, a gas, and/or a solid, as desired.

What is claimed:

1. A failure detection device comprising:
at least a bulk metallic glass (BMG) part formed of a material comprising one or more amorphous alloys, wherein, in response to a temperature, the BMG part has a plasticity for failure prediction or has a mechanical strength for failure detection.

2. The device of claim 1, wherein the BMG part comprises a multi-metallic strip comprising at least one strip formed of the one or more amorphous alloys throughout the at least one strip.

3. The device of claim 1, further comprising a holder for at least holding the BMG part, wherein the holder is formed of a material comprising an amorphous alloy.

4. The device of claim 1, wherein the failure detection device is a burst disc, a valve, a partition separator, or a combination thereof.

5. The device of claim 1, wherein the failure detection device is a burst disc for holding back pressurized gases.

6. The device of claim 1, wherein the failure detection device is a valve for holding back pressurized fluids.

7. The device of claim 1, wherein the BMG part is a cotter pin in a wheel, gear, or lid.

8. The device of claim 1, wherein the failure detection device is configured between a first partition containing a first material and a second partition containing a second material for providing passage of at least one of the first and the second materials for their mixing at a temperature range.

9. The device of claim 1, wherein the BMG part further comprises one or more non-amorphous metals selected from the group consisting of aluminum, bismuth, cobalt, copper, gallium, gold, indium, iron, lead, magnesium, mercury, nickel, potassium, plutonium, rare earth alloys, rhodium, silver, titanium, tin, uranium, zinc, zirconium, and mixtures thereof.

10. The device of claim 1, wherein the one or more amorphous alloys comprises an alloy of aluminum, bismuth, cobalt, copper, gallium, gold, indium, iron, lead, magnesium, mercury, nickel, potassium, plutonium, rare earth alloys, rhodium, silver, titanium, tin, uranium, zinc, zirconium, and mixtures thereof.

11. The device of claim 1, wherein the one or more amorphous alloys are described by the following molecular formula: (Zr, Ti)a(Ni, Cu, Fe)b(Be, Al, Si, B)c, wherein “a” is in the range of from 30 to 75, “b” is in the range of from 5 to 60, and “c” is in the range of from 0 to 50 in atomic percentages.

12. The device of claim 1, wherein the one or more amorphous alloys are described by the following molecular formula: (Zr, Ti)a(Ni, Cu)b(Be)c, wherein “a” is in the range of from 40 to 75, “b” is in the range of from 5 to 50, and “c” is in the range of from 5 to 50 in atomic percentages.

13. A failure detection method comprising:
providing a failure detection device comprising at least a bulk metallic glass (BMG) part, wherein the BMG part has a first mechanical strength at a low temperature range and a second mechanical strength at a high temperature range;
heating the failure detection device;
subjecting the failure detection device to a mechanical strength while heating; and
detecting a failure of the failure detection device in response to the subjected mechanical strength at the high temperature range.

14. The method of claim 13, wherein, if the subjected mechanical strength is higher than at least one of the first and the second mechanical strengths of the BMG part, the step of detecting a failure comprises at least partially tearing the BMG part of the failure detection device.

15. The method of claim 13, wherein the failure of the failure detection device provides a passage of a fluid through the failure detection device.

16. A failure control method comprising:
providing a failure detection device comprising at least a bulk metallic glass (BMG) part, wherein the BMG part has a first mechanical strength at a low temperature range and a second mechanical strength at a high temperature range;
heating the failure detection device;
subjecting the failure detection device to a mechanical strength while heating; and
predicting a failure of the failure detection device if a plasticity of the BMG part is measured during the heating.

17. The method of claim 16, wherein, if the plasticity of the BMG part is measured during the heating, the subjected mechanical strength is higher than at least one of the first and the second mechanical strengths or is between the first and the second mechanical strengths of the BMG part.

18. The method of claim 16, wherein the plasticity is measured by measuring a ductility or a malleability of the BMG part.

19. A method of using a failure detection device comprising:
providing the failure detection device comprising at least a bulk metallic glass (BMG) part, wherein the BMG part has a first mechanical strength at a low temperature range and a second mechanical strength at a high temperature range;
heating the failure detection device;
subjecting the failure detection device to a mechanical strength while heating; and
determining the subjected mechanical strength by measuring a plasticity of the BMG part in the failure detection device.

20. The method of claim 19, wherein the mechanical strength is determined to be higher than a lower mechanical strength of the first and the second mechanical strengths, if the plasticity is measured, if the BMG part is capable of local re-shaping, or if a failure of the BMG part is observed.

21. The method of claim 19, wherein the mechanical strength is determined to be lower than a lower mechanical strength of the first and the second mechanical strengths, if no plasticity is measured or if no failure of the BMG part is observed.

22. A method of using a failure detection device comprising:
providing the failure detection device comprising at least a bulk metallic glass (BMG) part, wherein the BMG part has a first mechanical strength at a low temperature range and a second mechanical strength at a high temperature range;
heating the failure detection device;
applying a mechanical strength to the failure detection device while heating, wherein the applied mechanical strength is between the first and the second mechanical strengths of the BMG part; and
monitoring the heating process by examining the BMG part of the failure detection device.

23. The method of claim 22, wherein the step of examining the BMG part comprises measuring a plasticity or observing a failure of the BMG part.

24. The method of claim 23, wherein
if the plasticity is measured, a heating temperature is determined to be between a glass transition temperature (Tg) and a crystallization temperature (Tx) of the BMG part; and
if a failure of the BMG part in the failure detection device is observed, the heating temperature is at least about Tx of the BMG part.

25. A method of using a failure detection device comprising:
selecting a BMG part according to a mechanical strength to be applied thereto such that the applied mechanical strength is between a first mechanical strength at a low temperature range of the BMG part and a second mechanical strength at a high temperature range of the BMG part;
providing a failure detection device comprising at least one selected BMG part;
heating the failure detection device to the high temperature range of the selected BMG part;
applying the mechanical strength to the at least one selected BMG part while heating; and
obtaining a failure of the failure detection device.

26. The method of claim 25, wherein the step of selecting a BMG part comprises selecting one or more amorphous alloys to form the BMG part, selecting a dimension, a shape, a structure of the BMG part, selecting a configuration of the BMG part in the failure detection device, selecting one or more non-amorphous metals or their alloys, or a combination thereof.

27. The method of claim 25, wherein the step of obtaining a failure comprises providing a protection or a switch of an electronic system, the electronic system comprising the failure detection device.

28. The method of claim 25, wherein the step of obtaining a failure comprises venting a pressurized gas or liquid through the failure detection device.

29. The method of claim 25, wherein the step of obtaining a failure comprises tearing the at least one selected BMG part of the failure detection device configured between a first partition containing a first reactant and a second partition containing a second reactant such that the first and the second reactants are mixed.
